(19) United States
(12) Patent Application Publication
(10) Pub. No.: US 2026/0058732 A1
(43) Pub. Date: Feb. 26, 2026

(54) Deployable Quantum Entanglement Swapping System

(71) Applicant: The Boeing Company, Arlington, VA (US)

(72) Inventors: Jennifer Lee Ellis, Calabasas, CA (US); Danny Myung Kon Kim, Agoura Hills, CA (US); Brett Alexander Yurash, Venice, CA (US); Shanying Cui, Calabasas, CA (US); Sofiane Merkouche, Tarzana, CA (US); Cameron Jean Taggesell, Santa Monica, CA (US)

(21) Appl. No.: 18/813,532

(22) Filed: Aug. 23, 2024

(51) Int. Cl. H04B 10/70; H04B 10/118; H04B 10/50

(52) U.S. Cl. CPC H04B 10/70; H04B 10/118; H04B 10/503

(57) ABSTRACT

A quantum entanglement system comprising a laser system, a spontaneous parametric down conversion crystal system, and a thermal management system. The laser system is configured to generate a laser beam. The spontaneous parametric down conversion crystal system comprises a spontaneous parametric down conversion crystal configured to receive the laser beam at a spontaneous parametric down conversion crystal and generate an entangled photon pair in response to the spontaneous parametric down conversion crystal receiving the laser beam. The thermal management system is configured to maintain the spontaneous parametric down conversion crystal at an annealing temperature during a generation of the entangled photon pair. A translation system is configured to move a position of the spontaneous parametric down conversion crystal. A

### BACKGROUND INFORMATION

### 1. Field

The present disclosure relates generally to communications and in particular, to communications using quantum states.

### 2. Background

A quantum network is comprised of devices such as quantum computers, quantum sensors, and quantum memories connected via quantum communications devices. These devices are also referred to as nodes and can be located aboard platforms such as ground stations and satellites.

These nodes or devices are intended to share quantum information in a secure manner. For example, devices in a quantum network are used to provide quantum key distribution to ensure secure communication.

With quantum keys, two parties can generate and share cryptographic keys with security guaranteed by the laws of quantum mechanics. The quantum keys are generated by transmitting quantum bits in the form of entangled photons. An attempt to eavesdrop on the communication disturbs the quantum states or destroys the entanglement of the photons. As a result, the two parties will know that a potential breach has occurred.

In another example, the quantum network can be used to transmit information in qubits. A qubit can be 0, 1, or in superposition of both 0 and 1 simultaneously.

These qubits can be represented by states in the photons. In one example, the polarization of a photon is an orientation of oscillation that can be manipulated to encode quantum information, with horizontal polarization representing 0, vertical polarization representing 1, or any quantum superposition of these states. This ability to exist in superposition states enables the use of photons as carriers of quantum information.

### SUMMARY

An embodiment of the present disclosure provides a quantum entanglement system comprising a laser system, a spontaneous parametric down conversion crystal system, a thermal management system, a translation system, and a photon entanglement swapper system. The laser system is configured to generate a first laser beam and a second laser beam. The spontaneous parametric down conversion crystal system comprises a number of spontaneous parametric down conversion crystals configured to receive the first laser beam at a first location in the number of spontaneous parametric down conversion crystals; generate a first entangled photon pair in response to the number of spontaneous parametric down conversion crystals receiving the first laser beam, wherein the first entangled photon pair comprises a first photon entangled with a second photon; receive the second laser beam at a second location in the number of spontaneous parametric down conversion crystals; and generate a second entangled photon pair in response to the number of spontaneous parametric down conversion crystals receiving the second laser beam, wherein the second entangled photon pair comprises a third photon entangled with a fourth photon. The thermal management system is configured to maintain the number of spontaneous parametric down conversion crystals at an annealing temperature during a generation of the first entangled photon pair and the second entangled photon pair. The translation system is configured to move a position of the number of spontaneous parametric down conversion crystals relative to the first laser beam and the second laser beam. The photon entanglement swapper system is configured to swap entanglement between the first entangled photon pair and the second entangled photon pair, wherein the second photon in the first entangled photon pair is combined with the third photon in the second entangled photon pair to form a combined photon pair in a Bell state and wherein the first photon in the first entangled photon pair becomes entangled with the fourth photon in the second entangled photon pair.

Another embodiment of the present disclosure provides a quantum entanglement system comprising a laser system, a spontaneous parametric down conversion crystal system, and a thermal management system. The laser system is configured to generate a laser beam. The spontaneous parametric down conversion crystal system comprises a spontaneous parametric down conversion crystal configured to receive the laser beam at a spontaneous parametric down conversion crystal and generate an entangled photon pair in response to the spontaneous parametric down conversion crystal receiving the laser beam. The thermal management system is configured to maintain the spontaneous parametric down conversion crystal at an annealing temperature during a generation of the entangled photon pair.

Yet another embodiment of the present disclosure provides a method for generating entangled photon pairs. A first laser beam is directed at a first location in a number of spontaneous parametric down conversion crystals. A first entangled photon pair is generated in response to the number of spontaneous parametric down conversion crystals receiving the first laser beam. The first entangled photon pair comprises a first photon entangled with a second photon. A second laser beam is directed at a second location in the number of spontaneous parametric down conversion crystals. A second entangled photon pair is generated in response to the number of spontaneous parametric down conversion crystals receiving the second laser beam. The second entangled photon pair comprises a third photon entangled with a fourth photon. The number of spontaneous parametric down conversion crystals is maintained at an annealing temperature during the generation of the first entangled photon pair and the second entangled photon pair. The second photon in the first entangled photon pair and the third photon in the second entangled photon pair are transmitted to a photon entanglement swapper system. The second photon in the first entangled photon pair and the third photon in the second entangled photon pair are interfered to form a combined photon pair in a Bell state. The first photon in the first entangled photon pair becomes entangled with the fourth photon in the second entangled photon pair.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial illustration of a quantum network in accordance with an illustrative embodiment;

FIG. 2 is an illustration of a block diagram of a quantum communications environment in accordance with an illustrative embodiment;

FIG. 3 is an illustration of a block diagram of a quantum entanglement system implemented using two or more platforms in accordance with an illustrative environment;

FIG. 4 is an illustration of a block diagram of a quantum entanglement system implemented in satellites in accordance with an illustrative embodiment;

FIG. 5 is an illustration of a block diagram of a laser generator and a laser system in accordance with an illustrative embodiment;

FIG. 6 is an illustration of a block diagram of a spontaneous parametric down conversion crystal system in accordance with an illustrative embodiment;

FIG. 7 is an illustration of a block diagram of a temperature controller in accordance with an illustrative embodiment;

FIG. 8 is a schematic illustration of a polarization analyzer in accordance with an illustrative embodiment;

FIG. 9 is an illustration of a block diagram of a Bell measurement system in accordance with an illustrative embodiment;

FIG. 10 is an illustration of a block diagram of a beam stabilization system in accordance with an illustrative embodiment;

FIG. 11 is an illustration of a block diagram of temperature control loops in accordance with an illustrative embodiment;

FIG. 12 is a pictorial illustration of a crystal management system for a spontaneous parametric down conversion crystal in accordance with an illustrative embodiment;

FIG. 13 is an illustration of a flowchart of a process for performing entanglement swapping in accordance with an illustrative embodiment;

FIG. 14 is an illustration of a flowchart of a process for generating entangled photon pairs in accordance with an illustrative embodiment;

FIG. 15 is an illustration of a flowchart for swapping photon entanglement in accordance with an illustrative embodiment; and

FIG. 16 is an illustration of a flowchart of a process for performing secure communications using the entangled photons in accordance with an illustrative embodiment.

### DETAILED DESCRIPTION

The illustrative embodiments recognize and take into account one or more different considerations as described herein. Quantum repeaters can be used to maintain the integrity of the quantum states in at least one of over long distances or in absences of lines of site between platforms using free space transmission.

Quantum repeaters that rely on entanglement swapping can be used to distribute entanglement between platforms that cannot directly interact because of a lack of a line of sight or a distance that is too great for reliable transmission of qubits. Another issue that can arise is an optical loss for other circumstances with respect to the quantum network architecture.

For example, entanglement swapping aboard a satellite can be important for long distance quantum communications. Losses incurred from optical transmission from satellite to ground can be on the order of 60-80 dB. Optical losses between satellites in orbit can be considerably less. With these lower losses, the entanglement distribution rates are calculated to be up to 40 dB higher for a few km-scale distances, and more for 10's of km scale distances. Therefore, the creation of a global quantum network requires the capability to conduct entanglement swapping between orbiting nodes.

Further, the use of quantum repeaters between satellites can enable communicating information between satellites that do not have a line of sight to each other.

One challenge with entanglement swapping with satellites is the generation of photon pairs that are highly entangled in one degree of freedom, but indistinguishable and uncorrelated in all other degrees of freedom. For example, photons can be generated that are entangled in their polarization. As a result, it is also desirable that the photons are indistinguishable and uncorrelated in the other degrees of freedom of frequency, time, and spatial mode. This lack of correlations in other degrees of freedom is an additional parameter used for entanglement swapping.

For example, two photons can be highly entangled without necessarily being swappable, such that the entanglement between these two photons cannot be transferred or shared between other photons. Current systems for swapping photons in space-based entangled photon sources do not have this indistinguishability trait.

In the illustrative example, two entangled photon pairs comprising four photons are created by pumping a number of spontaneous parametric down conversion crystals with a laser, in a χ⁽²⁾ non-linear process twice in two spatially distinct locations in a number of spontaneous parametric down conversion crystals. This indistinguishability eliminates any source of which-path information of the generated down converted photon pairs. Current techniques achieve indistinguishability using narrow bandwidth optical filters and single mode spatial filters at the cost of significant photon loss. To offset the loss from these filters, at least one of higher power lasers or superconducting single photon detectors are used with current systems.

However, these current systems are not deployable on a satellite case due to the size and power consumption. In the illustrative example, components with a lower size, weight, and power requirements are used for the laser source and detectors. These types of components can also be referred to as low SWAP components. For example, a femtosecond fiber laser and silicon avalanche photodiode (APD) detectors can be used in place of currently implemented devices.

For example, these components can be implemented such that the system power consumption in a satellite can be much lower than current systems used on the ground. Power consumption can be, for example, 55 W or less and the total system volume can be about 12 liters.

Further, entanglement swapping uses a high generation rate of entangled pairs that are indistinguishable. This type of entangled photon pair generation involves the use of high power, short pulse (femtosecond) lasers. However, this type of pump laser has high peak powers that can cause degradation to the number of spontaneous parametric down conversion crystals used to generate the entangled photons. This degradation to the number of spontaneous parametric down conversion crystals can result in a decline in the fidelity or rate of entangled photon pair generation over time.

The illustrative examples mitigate this degradation issue. The reduction in degradation can be performed by at least one of the operating the number of spontaneous parametric down conversion crystals at an elevated temperature or spatially translating the number of spontaneous parametric down conversion crystals so that the laser beam does not interact with any given spatial location on the number of spontaneous parametric down conversion crystals for a prolonged time.

In the illustrative example, entangled photon pairs are generated using a type II down conversion process. This type of photon generation results in pairs of photons that are entangled in their polarization.

In one illustrative example, the polarization entanglement is read out using four polarization analyzers. With this example, each polarization analyzer comprises two liquid crystal variable retarders (LCVRs), a polarizing beam splitter (PBS), and two avalanche photodiode detectors (APDs). This combination results in a total of 8 polarization retarders and 8 avalanche photodiode detectors.

This configuration increases the fraction of swapping events that can be detected, resulting in an increase in the overall entanglement swapping rate. Additionally, this configuration can provide redundancy and robustness to failures of a subset of the avalanche photodiode detectors or liquid crystal variable retarders. For example, one of the avalanche photodiode detectors in each of the polarization analyzers can fail and the system can continue to execute entanglement swapping.

Further, the illustrative examples also employ a number of control features to enable the quantum entanglement system to operate over an extended temperature range. These control features include an active laser beam steering feedback to maintain alignment and active temperature control on a number of select sensitive components. The active beam steering can provide an entanglement swapping system that has good spatial overlap at the Bell-state interference beamsplitter.

Thus, the illustrative examples provide a method, apparatus, and system for the quantum entanglement of photons. In one illustrative example, a quantum entanglement system comprises a laser system, a spontaneous parametric down conversion crystal system, and a thermal management system. The laser system is configured to generate a laser beam. The spontaneous parametric down conversion crystal system comprises a spontaneous parametric down conversion crystal configured to receive the laser beam at a spontaneous parametric down conversion crystal and generate an entangled photon pair in response to the spontaneous parametric down conversion crystal receiving the laser beam. The thermal management system is configured to maintain the spontaneous parametric down conversion crystal at an annealing temperature during a generation of the entangled photon pair.

The thermal management system enables increasing the lifespan of crystals used to generate entangled photons. Further, this thermal management system also enables selecting laser generators having a smaller size and configuration. These types of lasers can increase degradation of a crystal as compared to larger lasers without the use of the thermal management system. Further, with the use of temperature control loops for other components such as a second harmonic generation crystal and a spectral filter, increased performance in generating entangled photon pairs can occur.

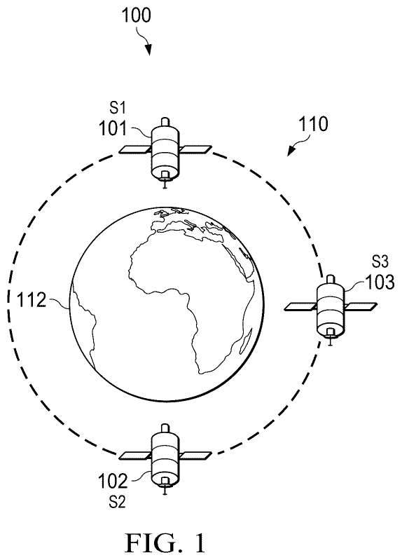

With reference now to the figures and, in particular, with reference to FIG. 1, a pictorial illustration of a quantum network is depicted in accordance with an illustrative embodiment. The quantum network can be comprised of various combinations of ground and satellite based quantum nodes.

In this illustrative example, quantum network 100 comprises nodes in the form of satellites 110 orbiting Earth 112. In this example, satellites 110 comprise satellite S1 101, satellite S2 102, and satellite S3 103.

In this illustrative example, direct quantum communications between satellite S1 101 and satellite S2 102 cannot occur because the line of site is absent between these two satellites. In another example, a line of sight is present, but the distance between the satellite S1 101 and satellite S2 102 cannot occur because of the distance between the satellites.

With these situations, satellite S3 103 has components that enable the satellite S3 103 to operate as a quantum repeater in quantum network 100. In this example, satellite S3 103 is a quantum repeater that uses entanglement swapping to establish entanglement between satellite S1 101 and satellite S2 102.

In this example, satellite S1 101 and satellite S2 102 both generate entangled photons pairs. An entangled photon pair is a pair of photons that are entangled with each other. Satellite S1 101 generates an entangled photon pair comprising photon A entangled with photon B. Satellite S2 102 generates an entangled photon pair comprising photon C entangled with photon D.

In this illustrative example, the generation of entangled photon pairs is performed in a manner that reduces or mitigates degradation of spontaneous parametric down conversion crystals in response to laser beams being directed at the crystals to generate entangled photon pairs.

With the use of these spontaneous parametric down conversion crystals in a space environment, these crystals are maintained at an annealing temperature during the generation of the photons for the entangled photon pairs using heat. In this illustrative example, the spontaneous parametric down conversion crystals are constantly maintained at the annealing temperature. This annealing temperature reduces degradation of the crystals. Generated entangled photon pairs using crystals maintained at an annealing temperature can repair and improve the quality of a spontaneous parametric down conversion crystal.

Additionally, the degradation to the spontaneous parametric down conversion crystals in satellite S1 101 and satellite S2 102 can also be reduced by translating the spontaneous parametric down conversion crystals such that the laser beams are directed to different locations in the spontaneous parametric down conversion crystals at different times when generating the entangled photon pairs.

Using both of these features in satellite S1 101 and satellite S2 102 can reduce the degradation of spontaneous parametric down conversion crystals in the satellites. As a result, the lifespan of spontaneous parametric down conversion crystals in satellite S1 101 and satellite S2 102 can be increased as compared to current techniques. This increase in the lifespan can reduce the amount of maintenance needed for satellites.

With this example, satellite S1 101 transmits photon B to satellite S3 103. Satellite S2 102 transmits photon C to satellite S3 103. Satellite S3 103 performs entanglement swapping in which photon B is combined with photon C and the two photons are measured on the Bell-state basis. Upon detection of photons B and C in a Bell state, photon A at satellite S1 101 becomes entangled with photon D at satellite S2 102.

In this example, satellite S3 103 performs a measurement of the combined photon pair comprising photon B and photon C. This measurement can be compared with measurements made by satellite S1 101 of photon A and satellite S2 102 of photon D. These measurements can be used to ensure that eavesdropping has not occurred in the transmission of photon B and C to satellite S3 103. If the eavesdropping has not occurred, then photon A and photon D can be used in performing quantum communications.

FIG. 1 is intended as an example, and not as an architectural limitation for the different illustrative embodiments. For example, the platforms in quantum network 100 can take a number of other forms in addition to or in place of the satellites illustrated in quantum network 100. For example, the platforms can be selected from at least one of a mobile platform, a stationary platform, a land-based structure, an aquatic-based structure, or a space-based structure. With respect to space-based structures, platforms can also be selected from at least one of a spacecraft, a space station, a space shuttle, a rocket, or some other space-based structure. As another example, a land-based structure can be a ground station such as a building, the communication center, or some other ground-based station.

As used herein, “a number of” when used with reference to items, means one or more items. For example, “a number of different types of networks” is one or more different types of networks.

Further, as used herein, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Further, in another example, a ground station can be used in place of satellite S3 103 that has a line of sight to both satellite S1 101 and satellite S2 102.

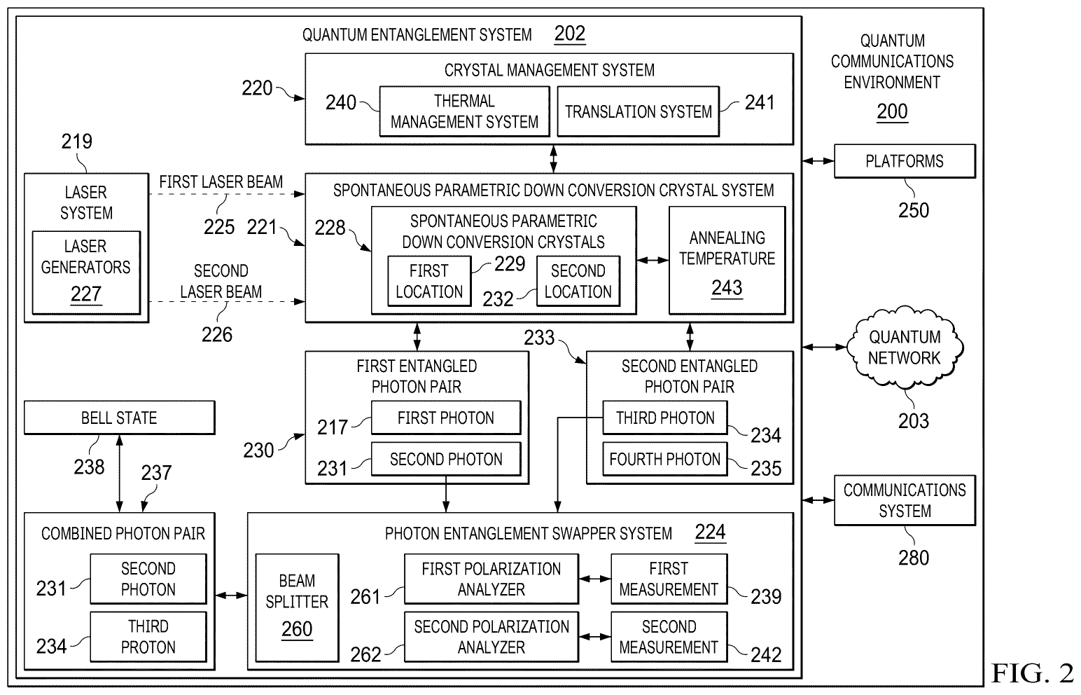

With reference now to FIG. 2, an illustration of a block diagram of a quantum communications environment is depicted in accordance with an illustrative embodiment. In this illustrative example, quantum communications environment 200 includes components that can be implemented in hardware such as the hardware shown in quantum network 100 in FIG. 1. In this illustrative example, quantum entanglement system 202 is an example of a system that can be used with quantum network 203 to facilitate quantum communications.

Quantum entanglement system 202 is comprised of a number of different components. In this illustrative example, quantum entanglement system 202 comprises laser system 219, spontaneous parametric down conversion crystal system 221, crystal management system 220, and photon entanglement swapper system 224.

In this example, laser system 219 is a hardware system and is configured to generate first laser beam 225 and second laser beam 226. Laser system 219 includes a number of laser generators 227. The number of laser generators 227 is comprised of hardware that generates the laser beams.

In one example, the number of laser generators 227 is two laser generators in which each laser generator generates one of the two laser beams. In another illustrative example, the number of laser generators 227 is one laser generator in which the laser generator generates a laser beam that is split to form first laser beam 225 and second laser beam 226.

Spontaneous parametric down conversion crystal system 221 is comprised of a number of spontaneous parametric down conversion crystals 228. The number of spontaneous parametric down conversion crystals 228 can take a number of different forms depending on the type of laser beam being used. In one illustrative example, the number of spontaneous parametric down conversion crystals 228 is comprised of a number of materials selected from at least one of periodically poled potassium titanyl phosphate (ppKTP), potassium titanyl phosphate (KTP), potassium titanyl arsenate (KTA), rubidium titanyl phosphate (RTP), rubidium doped potassium titanyl phosphate (RB:KTP), potassium dihydrogen phosphate (KDP), bismuth triborate (BiBO), beta barium borate (BBO), periodically poled lithium niobate (PPLN), or some other suitable type of material.

During operation of quantum entanglement system 202, the number of spontaneous parametric down conversion crystals 228 receives first laser beam 225 at first location 229 in the number of spontaneous parametric down conversion crystals 228. The number of spontaneous parametric down conversion crystals 228 generates first entangled photon pair 230 in response to the number of spontaneous parametric down conversion crystals 228 receiving first laser beam 225. In this example, first entangled photon pair 230 comprises first photon 217 entangled with second photon 231.

Further in this example, the number of spontaneous parametric down conversion crystals 228 receives second laser beam 226 at second location 232 in the number of spontaneous parametric down conversion crystals 228. The number of spontaneous parametric down conversion crystals 228 generates second entangled photon pair 233 in response to the number of spontaneous parametric down conversion crystals 228 receiving second laser beam 226. In this example, second entangled photon pair 233 comprises third photon 234 entangled with fourth photon 235.

In this example, directing first laser beam 225 and second laser beam 226 in the number of spontaneous parametric down conversion crystals 228 can cause degradations in the number of spontaneous parametric down conversion crystals 228. These degradations can be selected from at least one of a thermal stress from rapid heating and cooling, changing an optical property of the crystal, a crack in the crystal, a surface damage in the crystal, grey tracking, or other types of undesired inconsistencies. In this example, grey tracking is the generation of localized regions with reduced transparency after exposure to laser beam. These changes can reduce the optical efficiency of the crystal resulting in a lower generation of entangled photon pairs. These degradations can also be referred to as inconsistencies or laser induced damage.

In this example, crystal management system 220 is a physical system that can reduce the generation of undesired inconsistencies in the number of spontaneous parametric down conversion crystals 228. As depicted in this example, crystal management system 220 comprises thermal management system 240 and translation system 241.

Thermal management system 240 can maintain the number of spontaneous parametric down conversion crystals 228 at annealing temperature 243 during the generation of first entangled photon pair 230 and second entangled photon pair 233. In this example, thermal management system 240 can maintain the number of spontaneous parametric down conversion crystals 228 at annealing temperature 243 that is selected to minimize inconsistencies in the number of spontaneous parametric down conversion crystals 228 while maximizing photon pair generation by the number of spontaneous parametric down conversion crystals 228.

In this example, annealing temperature 243 can be a single temperature, or a range of temperatures. In one example, thermal management system 240 can maintain the number of parametric down conversion crystals at annealing temperature 243 that is from about 50 degrees C. to about 150 degrees C.

In this example, thermal management system 240 performs at least one of heating or cooling of the number of spontaneous parametric down conversion crystals 228 to maintain the number of spontaneous parametric down conversion crystals 228 at annealing temperature 243 during the generation of first entangled photon pair 230 and second entangled photon pair 233. Thermal management system 240 can maintain the number of spontaneous parametric down conversion crystals 228 at annealing temperature 243 during the generation of first entangled photon pair 230 and second entangled photon pair 233 using a proportional-integral-derivative control loop.

In this example, crystal management system 220 can also include translation system 241. Translation system 241 is a physical system that moves the number of spontaneous parametric down conversion crystals 228 to different positions relative to first laser beam 225 and second laser beam 226. The position can be the position for one spontaneous parametric down conversion crystal or for multiple spontaneous parametric down conversion crystals when the number of spontaneous parametric down conversion crystals 228 is more than one crystal.

In these examples, translation system 241 can move the position of the number of spontaneous parametric down conversion crystals 228 on a number of axes. For example, the translation system can move one or more crystals in the number of spontaneous parametric down conversion crystals 228 along a single axis for multiple axes.

In this example, photon entanglement swapper system 224 is a hardware system and can swap the entanglement between first entangled photon pair 230 and second entangled photon pair 233. In this example, second photon 231 in first entangled photon pair 230 is combined with third photon 234 in second entangled photon pair 233 to form combined photon pair 237 in Bell state 238. In swapping of entanglements between first entangled photon pair 230 and second entangled photon pair 233, first photon 217 in first entangled photon pair 230 becomes entangled with fourth photon 235 in second entangled photon pair 233.

In this illustrative example, quantum entanglement system 202 can be deployable by being connected to a number of platforms 250. The number of platforms 250 can be selected from at least one of a mobile platform, a stationary platform, a land-based structure, an aquatic-based structure, a space-based structure, a ground station, a satellite, a space station, a spacecraft, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a submarine, an automobile, a power plant, a bridge, a dam, a house, a manufacturing facility, a building, or some other suitable type of platform. For example, quantum entanglement system 202 can be connected to a single platform such as a satellite. In other examples, the system can be distributed through multiple platforms. In this manner, quantum entanglement system 202 is a deployable quantum swapping entanglement system.

When one component is “connected” to another component, the connection is a physical connection. For example, a first component, such as a quantum entanglement system, can be considered to be physically connected to a second component, such as a platform, by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

In one illustrative example, photon entanglement swapper system 224 comprises beam splitter 260, first polarization analyzer 261, and second polarization analyzer 262. In this example, beam splitter 260 is an optical device and receives second photon 231 from first entangled photon pair 230 and third photon 234 from second entangled photon pair 233. Beam splitter 260 outputs second photon 231 and third photon 234 as combined photon pair 237 in Bell state 238.

In this example, first polarization analyzer 261 receives combined photon pair 237 in Bell state 238 and generates first measurement 239 of combined photon pair 237 in Bell state 238. Further, second polarization analyzer 262 receives combined photon pair 237 in Bell state 238 and generates second measurement 242 of combined photon pair 237 in Bell state 238. In this example, these polarization analyzers are hardware devices that measure the polarization of photons to generate first measurement 239 and second measurement 242.

In one illustrative example, communications system 280 is also present in quantum communications environment 200. With this example, communications system 280 can determine whether eavesdropping has occurred using first measurement 239 and second measurement 242. In this depicted example, communications system 280 can include at least one of a computing device, a processor, and other components that include processes that perform an analysis to determine whether eavesdropping has occurred. This analysis can be implemented using program code that is run by a computing device, the processes, or other component.

In this depicted example, communications system 280 can include at least one of a computing device, a processor, and other components that include processes that perform an analysis to determine whether eavesdropping has occurred. This analysis can be implemented using program code that is run by a computing device, the processes, or other component. These measurements can be compared to measurements of first photon 217 and fourth photon 235 to determine whether the correct correlation is present between first photon 217, second photon 231, third photon 234, and fourth photon 235. Communications system 360 can perform a secure communication of data using first photon 217 and fourth photon 235 in response to an absence of eavesdropping. The secure communications can take a number of different forms. For example, the secure communications can be the secure communication of data that is selected from a group of techniques comprising quantum key distribution, quantum teleportation, quantum secret sharing, entanglement-based quantum authentication, and other suitable types of quantum techniques for communicating information.

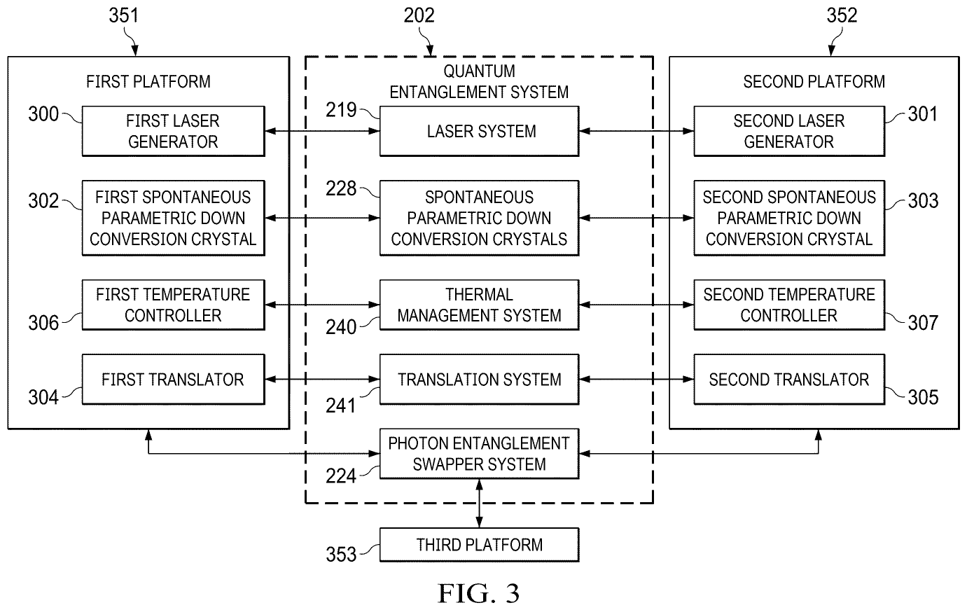

Turning next to FIG. 3, an illustration of a block diagram of a quantum entanglement system implemented using two or more platforms is depicted in accordance with an illustrative environment.: In the illustrative examples, the same reference numeral may be used in more than one figure. This reuse of a reference numeral in different figures represents the same element in the different figures.

As depicted in this example, laser system 219 comprises first laser generator 300 that generates the first laser beam 225 in first platform 351 and second laser generator 301 that generates second laser beam 226 in second platform 352. Further, the number of spontaneous parametric down conversion crystals 228 comprises a first spontaneous parametric down conversion crystal 302 in first platform 351 and second spontaneous parametric down conversion crystal 303 in second platform 352.

In this example, thermal management system 240 comprises first temperature controller 306 in first platform 351 that is configured to maintain first spontaneous parametric down conversion crystal 302 at annealing temperature 243 during the generation of first entangled photon pair 230 and second temperature controller 307 in second platform 352 that is configured to maintain second spontaneous parametric down conversion crystal 303 at annealing temperature 243 during the generation of second entangled photon pair 233.

Further, translation system 241 comprises a first translator 304 in first platform 351 that is configured to move first spontaneous parametric down conversion crystal 302 and second translator 305 in second platform 352 that is configured to move second spontaneous parametric down conversion crystal 303. In this example, photon entanglement swapper system 224 is connected to a platform selected from a group comprising first platform 351, second platform 352, and third platform 353.

These platforms can take a number of forms. For example, wherein first platform 351, second platform 352, and third platform 353 are each selected from a group comprising a mobile platform, a stationary platform, a land-based structure, an aquatic-based structure, a space-based structure, a ground station, a satellite, a space station, a spacecraft, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a submarine, an automobile, a power plant, a bridge, a dam, a house, a manufacturing facility, and a building.

For example, first platform 351 can be a first satellite and second platform 352 can be a second satellite. In this example, third platform 353 can be a third satellite or ground station.

Further, in another illustrative example, photon entanglement swapper system 224 can be connected in first platform 351 or second platform 352 instead of in third platform 353.

The illustration of quantum communications environment 200 in the different components in this environment in FIGS. 2-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

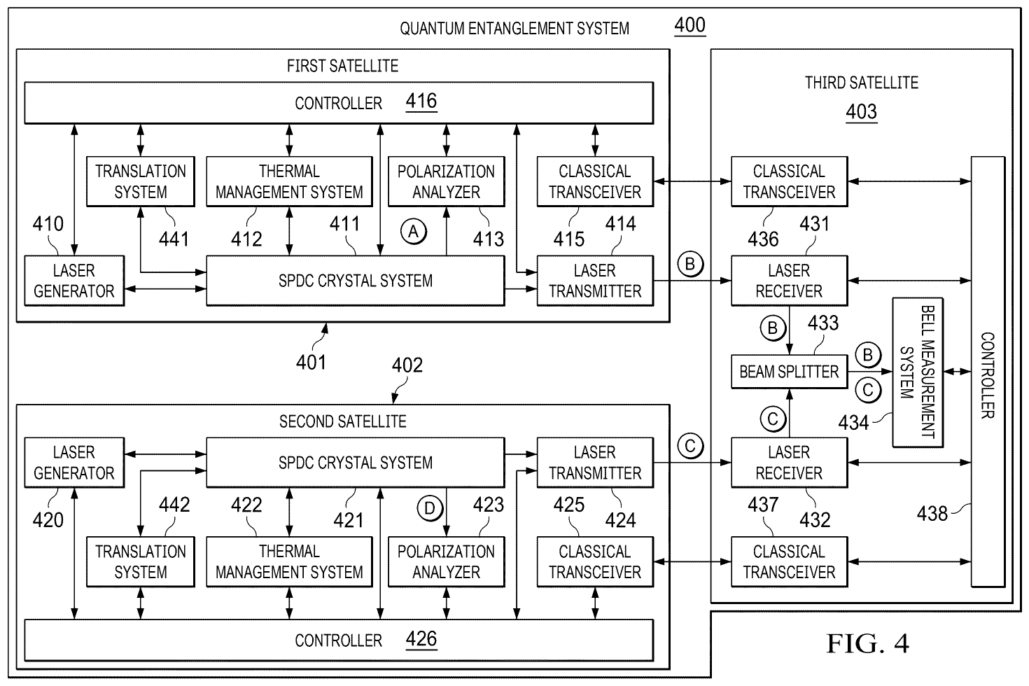

With reference next to FIG. 4, an illustration of a block diagram of a quantum entanglement system implemented in satellites is depicted in accordance with an illustrative embodiment. In this illustrative example, quantum entanglement system 400 is an example of an implementation for quantum entanglement system 202 in FIG. 2. As depicted, the system is distributed through three satellites, first satellite 401, second satellite 402, and third satellite 403. The components in the satellites can be examples of components used to implement satellite S1 101, satellite S2 102, and satellite S3 103 in FIG. 1.

In this illustrative example, first satellite 401 comprises laser generator 410, spontaneous parametric down conversion (SPDC) crystal system 411, thermal management system 412, translation system 441, polarization analyzer 413, laser transmitter 414, classical transceiver 415, and controller 416. Further in this example, second satellite 402 comprises laser generator 420, spontaneous parametric down conversion (SPDC) crystal system 421, thermal management system 422, translation system 442, polarization analyzer 423, laser transmitter 424, classical transceiver 425, and controller 426. As depicted, third satellite 403 comprises laser receiver 431, laser receiver 432, beam splitter 433, Bell measurement system 434, classical transceiver 436, classical transceiver 437, and controller 438.

In this illustrative example, the transmission of the laser beams and photons are free space. In some illustrative examples, the transmission of laser beams and photons within the satellites can be performed using optical fibers in addition to or in place of free space.

In this illustrative example, controller 416 controls the operation of the different components within satellite 401. In similar fashion, controller 426 controls the operation of components within satellite 402. Controller 438 controls the operation of components within satellite 403 and can perform analysis of various measurements made by these components.

These controllers can be implemented using various types of hardware. For example, these controllers include processes implemented in program instructions that are configured to run on hardware such as a processor unit. In another example, firmware in the form of program instructions and data can be stored in persistent memory to run on a processor unit.

In this example, the hardware can take a form selected from at least one of a processor unit circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array (FPLA), a field-programmable gate array (FPGA), and other suitable hardware devices.

In one example, a number of processor units can be used to implement the controllers. When multiple processor units are present, these processor units can be of the same type or different types of processor units. For example, the number of processor units used in a controller can be selected from at least one of a single core processor, a dual-core processor, a multi-processor core, a general-purpose central processing unit (CPU), a graphics processing unit (GPU), a digital signal processor (DSP), or some other type of processor unit.

For example, these controllers can perform operations selected from at least one of manage control loops, record photon detection events, correlate photon detection events, identify coincident events for at least one of detecting or verifying the entanglement, or other operations.

In this illustrative example, laser generator 410 in first satellite 401 sends a laser beam into SPDC crystal system 411 to generate an entangled photon pair AB. In this example, entangled photon pair AB comprises photon A and photon B that are entangled with each other in this photon pair. In this illustrative example, laser generator 420 in second satellite 402 sends a laser beam into SPDC crystal system 421 to generate an entangled photon pair CD. In this example, entangled photon pair CD comprises photon C and photon D that are entangled with each other in this photon pair.

In this example, entangled photon pair AB is an example of first entangled photon pair 230 in FIG. 2. Photon A is an example of first photon 217 and photon B is an example of second photon 231 in FIG. 2. Further, entangled photon pair CD is an example of second entangled photon pair 233 in FIG. 2. Photon C is an example of third photon 234 and photon D is an example of fourth photon 235 in FIG. 2.

In this illustrative example, thermal management systems are used to maintain the crystals at desired temperatures to increase the life span or longevity of the crystals. As depicted, thermal management system 412 manages the temperature of SPDC crystal system 411, and thermal management system 422 manages the temperature of SPDC crystal system 421. In this example these temperatures are maintained during the generation of the entangled photon pairs. Further, these temperatures can be maintained even when entangled photon pairs are not being generated.

Further in this example, translation system 441 moves a number of crystals in SPDC crystal system 411 and translation system 442 moves a position of a number of crystals in SPDC crystal system 421 as laser beams are directed towards the number of crystals in these SPDC crystal systems during the generation of entangled photon pairs by these SPDC crystal system. This movement of the crystals by these translation systems reduces degradation that may occur from laser beams being directed towards the crystals.

In this illustrative example, the anneal temperature is selected to mitigate degradation to these crystals from laser beams. Further, with the use of these thermal management systems, laser generators can be selected that have short wavelengths and high peak powers to produce entangled photons that are compatible with reduced power and size of single photon detectors.

As depicted, photon B from entangled photon pair AB is transmitted from first satellite 401 to third satellite 403 using laser transmitter 414. Photon B is received at third satellite 403 by laser receiver 431 in third satellite 403.

In this example, photon C from entangled photon pair CD is transmitted from second satellite 402 to third satellite 403 by laser transmitter 424. Photon C is received at third satellite 403 by laser receiver 432 in third satellite 403.

In this illustrative example, laser transmitter 414 and laser transmitter 424 can be implemented using a telescope or an aperture that directs photons out over the free space link to third satellite 403. Other components such as fast and slow steering loops can be used to control the beam pointing of the laser beam leaving the satellite. Also, the laser transmitters can also include a beacon laser for targeting and a beacon for polarization measurement and feedback control to correct for the relative orientation of the satellites.

Laser receiver 431 and laser receiver 432 can include similar components that are designed to direct photons from the free space link to beam splitter 433. In this example, beam splitter 433 is a nonpolarizing beam splitter.

In this illustrative example, beam splitter 433 receives photon B and photon C from laser receiver 431 and laser receiver 432 and entangles these two photons with each other. This entanglement results in the swapping of entanglement between entangled photon pair AB and entangled photon pair CD. In this example, photon B is combined with photon C to form a combined photon pair in a Bell state. Further, swapping the entanglement results in photon A becoming entangled with photon D. In this example, measurements of the combined photons can be made using Bell measurement system 434.

Further in this illustrative example, photon A in first satellite 401 is sent from SPDC crystal system 411 to polarization analyzer 413. In response to receiving photon A, polarization analyzer 413 measures the polarization state of photon A. Additionally, photon D in second satellite 402 is sent to polarization analyzer 423 from SPDC crystal system 421. In response to receiving photon D, polarization analyzer 423 measures the polarization state of photon D.

In this illustrative example, the measurements of the polarization states of photon A, photon D, photon B, and photon C can be sent between the satellites using classical transceivers. For example, measurements can be sent between first satellite 401 and third satellite 403 using classical transceiver 415 in first satellite 401 and classical transceiver 436 in third satellite 403. Further, measurements can be sent between second satellite 402 and third satellite 403 using classical transceiver 425 in second satellite 402 and classical transceiver 436 in third satellite 403.

These measurements can be used to determine whether eavesdropping has occurred with respect to the transmission of photon B from first satellite 401 and photon C from second satellite 402 to third satellite 403. For example, a tomographic analysis of four-fold coincident data from measuring the state of photon B and photon C can be used to reconstruct the state of photons A and D to verify against the target entangled state. In this example, the test entangled state is the state of the entangled photon pair AD in which photon A is measured by polarization analyzer 413 and photon D is measured by polarization analyzer 423, when heralded by detection of photons B and C in the Bell measurement system 434. The target entangled state for photons A and D in the entangled photon pair AD is determined by the results of the Bell measurement system 434.

In this example, the analysis is performed to identify and analyze four-fold coincident events. The events are for example, two entangled photon pairs are successfully produced, where the first entangled photon pair is produced on first satellite 401 in SPDC crystal system 411 and the second entangled photon pair is produced on second satellite 402 in the SPDC crystal system 421. The analysis then determines whether all four photons are successfully detected. Then four-fold photon detection events are identified and a determination is made of the entanglement between photon A and photon D.

If eavesdropping is not present, then photon A and photon D are used in performing secure communications. A number of different types of communications can be performed using these photons. For example, these photons can be used to generate and distribute quantum keys.

Thus, entanglement between photons such as photon A and photon D forming entangled photon pair AD on remote satellites can occur through entanglement swapping even though a line of sight is not present between the satellites. In this example, the swapping occurs through interfering photon B and photon C using beam splitter 433 at third satellite 403. The swapping occurs even though interaction between photon A and photon D has not occurred.

The illustration of quantum entanglement system 400 is presented as one illustrative example and not meant to limit the manner in which other quantum entanglement swapping systems can be implemented.

For example, a single classical transceiver can be used in third satellite 403 in place of the two classical transceivers depicted for this example. In the illustrative example, second satellite 402 can use classical transceiver 425 to exchange information with classical transceiver 415 in first satellite 401. Example, first satellite 401 and second satellite 402 can each also include a translation system in addition to or in place of the thermal management systems depicted in the satellites.

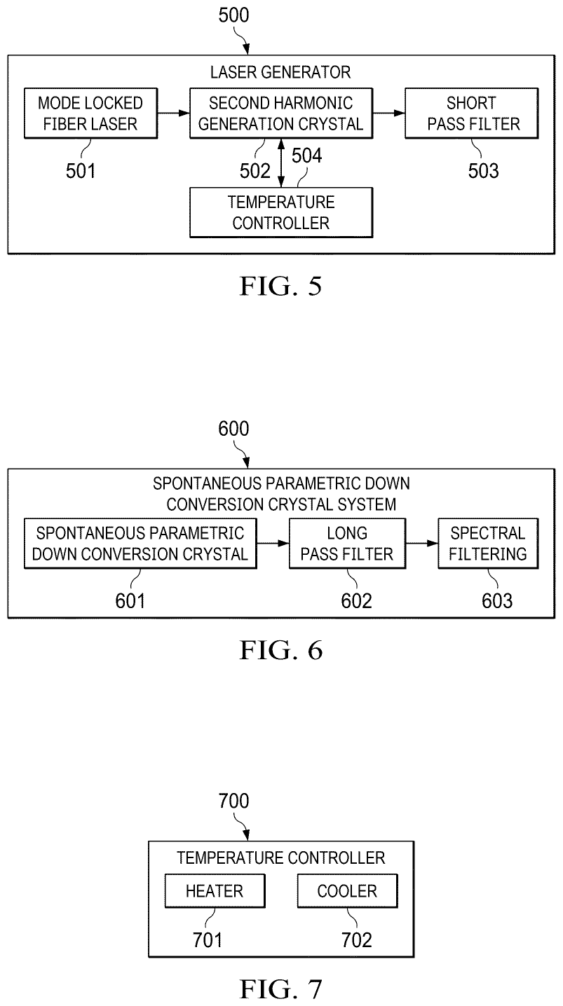

With reference to FIG. 5, an illustration of a block diagram of a laser generator and a laser system is depicted in accordance with an illustrative embodiment. Laser generator 500 is an example of an implementation for a laser generator in the number of laser generators 227 in FIG. 2, laser generator 410 in FIG. 4, and laser generator 410 in FIG. 4. As depicted, laser generator 500 comprises mode locked fiber laser 501, second harmonic generation (SHG) crystal 502, short pass filter 503, and temperature controller 504.

In this illustrative example, mode locked fiber laser 501 is a type of laser generator that generates ultra-short pulses of light by mode-locking within an optical fiber using the properties of the optical fiber to create and maintain the short pulse duration. For example, a femtosecond fiber laser can be used. In this illustrative example, the laser generates laser beam pulses having a wavelength of 1560 nm, which are frequency doubled to 780 nm in a nonlinear crystal.

In this example, second harmonic generation crystal 502 is a bismuth triborate (BiBO) crystal and received the laser beam generated by mode locked fiber laser 501. Second harmonic generation crystal 502 doubles the frequency of laser beam received from mode locked fiber laser 501. This doubling of the frequency results in laser beam pulses having a wavelength of 390 nm. The 390 nm laser beam pulses are used as the pump to create entangled photon pairs.

Laser beam output from second harmonic generation crystal 502 is sent through short pass filter 503 to be output as the laser beam used as the pump light for use in the spontaneous parametric down conversion (SPDC) process. Short pass filter 503 allows wavelengths shorter than a selected cutoff such as 390 nm to be output from laser generator 500.

In this illustrative example, temperature controller 504 controls the temperature of second harmonic generation crystal 502 to maintain the second harmonic generation crystal at the optimal phase matching temperature to maximize the amount of 390 nm light generated.

In other examples, entangled photon wavelengths from 400 nm to 1000 nm, which corresponds to pump photon wavelengths from laser generator being from 200 nm to 500 nm. In some examples, entangled photon wavelengths of 525 nm to 850 nm can be used, corresponding to pump photon wavelengths of 212 nm to 425 nm.

With reference now to FIG. 6, an illustration of a block diagram of a spontaneous parametric down conversion crystal system is depicted in accordance with an illustrative embodiment. In this illustrative example, spontaneous parametric down conversion crystal system 600 is an example of an implementation for spontaneous parametric down conversion crystal system 221 in FIG. 2. This system is also an example of an implementation of SPDC crystal system 411 and SPDC crystal system 421 in FIG. 4. As depicted, spontaneous parametric down conversion crystal system 600 comprises spontaneous parametric down conversion crystal 601, long pass filter 602, and spectral filtering 603.

In this example, spontaneous parametric down conversion crystal 601 can be comprised of a number of materials selected from at least one of periodically poled potassium titanyl phosphate (ppKTP), potassium titanyl phosphate (KTP), potassium titanyl arsenate (KTA), rubidium titanyl phosphate (RTP), rubidium doped potassium titanyl phosphate (RB:KTP), potassium dihydrogen phosphate (KDP), bismuth triborate (BiBO), beta barium borate (BBO), periodically poled lithium niobate (PPLN), and other suitable materials.

The selection of the material for spontaneous parametric down conversion crystal system 600 can depend on a number of factors such as characteristics of the pump pulse, optimizing the rate of entangled photon pair production, optimizing the degree of entanglement of entangled photon pair, and the indistinguishability or swapability of entangled photon pairs. In this example ppKTP can be used with laser generator 500 in FIG. 5 that generates a laser beam pulse of 390 nm.

In this illustrative example, long pass filter 602 can be used to remove the residual 390 nm pump light output from spontaneous parametric down conversion crystal 601. This filtering is performed to ensure only the entangled photons at the desired wavelengths such as 780 nm are present. Other wavelengths can result in incorrect measurements by the detectors and the polarization analyzers.

In this depicted example, spectral filtering 603 is performed to prepare the entangled photon pairs AB and CD. This filtering removes photon pairs that are created by the spontaneous parametric down conversion crystal 601 that are not sufficiently indistinguishable to be able to undergo the entanglement swapping operation. Spectral filtering can be accomplished for example using an interference filter, a distributed Bragg reflector, or other suitable optical element.

Turning now to FIG. 7, an illustration of a block diagram of a temperature controller is depicted in accordance with an illustrative embodiment. In this illustrative example, temperature controller 700 is an example of the component that can be used in thermal management system 240 in FIG. 2. Temperature controller 700 is an example of first temperature controller 306 and second temperature controller 307 in FIG. 3.

In this example, temperature controller 700 operates to maintain a spontaneous parametric down conversion crystal at an annealing temperature. Maintaining the annealing temperature can involve at least one of heating or cooling the crystal depending on the environment.

In this example, temperature controller 700 comprises at least one of heater 701 or cooler 702. In this illustrative example, heater 701 can be, for example, an induction heater, an infrared heater, a resistive heater, a Peltier heater, or some other suitable type of heater. Cooler 702 can be selected from at least one of a cryogenic cooler, a Peltier cooler, or some other suitable type of cooler.

In this example, the spontaneous parametric down conversion crystal is a poled potassium titanyl phosphate (ppKTP), and the laser generator generates a laser beam pulse having a wavelength of 390 nm. With this example, temperature controller 700 can maintain an annealing temperature that is about 120 degrees C.

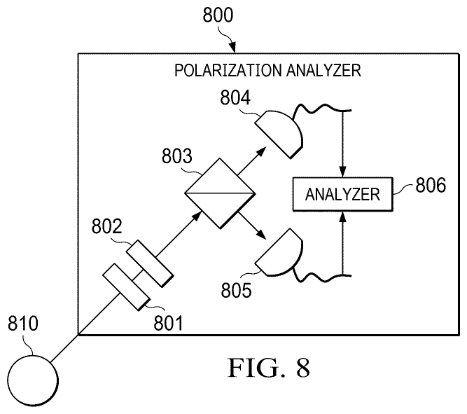

Turning now to FIG. 8, a schematic illustration of a polarization analyzer is depicted in accordance with an illustrative embodiment. In this illustrative example, polarization analyzer 800 is an example of an implementation of polarization analyzer 413 and polarization analyzer 423 in FIG. 4. As depicted, polarization analyzer 800 comprises liquid crystal variable retarder (LCVR) 801, liquid crystal variable retarder (LCVR) 802, polarizing beam splitter (PBS) 803, avalanche photodiode detector (APD) 804, avalanche photodiode detector (APD) 805, and analyzer 806.

In this example, photon 810 is sent though liquid crystal variable retarder (LCVR) 801 and liquid crystal variable retarder (LCVR) 802 in polarization analyzer 800. These liquid crystal variable retarders can be operated to control the polarization state of light in an electrically tunable manner. The retardance difference (phase delay) between the orthogonal polarization components is controlled by the voltage applied to the liquid crystal variable retarder.

Another parameter that can be set of the liquid crystal variable retarder is the optical axis (slow axis), which controls how the liquid crystal variable retarder interacts with light. In this example, liquid crystal variable retarder is fixed at 22.5 degrees or 45 degrees depending on the liquid crystal variable retarder. In this example, the angle is referenced from the vertical axis or axis in and out of the plane of the optics.

In this example, liquid crystal variable retarder 801 is fixed at an axis angle of 22.5 degrees and a retardance of 0.5 waves for an antidiagonal-diagonal (AD) polarization basis and liquid crystal variable retarder 802 is sent to an angle of 45 degrees and a retardance of 0.25 waves for a right-left (RL) polarization basis.

Photon 810 output from the liquid crystal variable retarders is sent to polarizing beam splitter 803. This use of the liquid crystal variable retarders in conjunction with polarizing beam splitter 803 causes the entangled photons to be projected into different polarization bases for read out by detectors such as avalanche photodiode detector (APD) 804 and avalanche photodiode detector (APD) 805.

In this example, the entangled photon pairs are created in the HV (horizontal-vertical) polarization basis. If entangled photon pairs are truly entangled, the entangled photon pairs will be correlated in the other canonical polarization basis as well such as RL (right-left) and AD (antidiagonal-diagonal).

Applying the correct retardance to the right liquid crystal variable retarder such as liquid crystal variable retarder 801 or liquid crystal variable retarder 802 transforms the HV photons into these other polarization basis for measurement.

In this illustrative example, analyzer 806 operates to analyze detections of photons by avalanche photodiode detector 804 and avalanche photodiode detector 805. In this illustrative example, analyzer 806 can be implemented using various types of devices and processors. For example, analyzer 806 can be comprised of a time to digital converter (TDC) and a field programmable gate array (FPGA). The time to digital converter can measure the time between detections of photons by the avalanche photodiode detectors. The field programmable gate array can be configured to analyze those measurements.

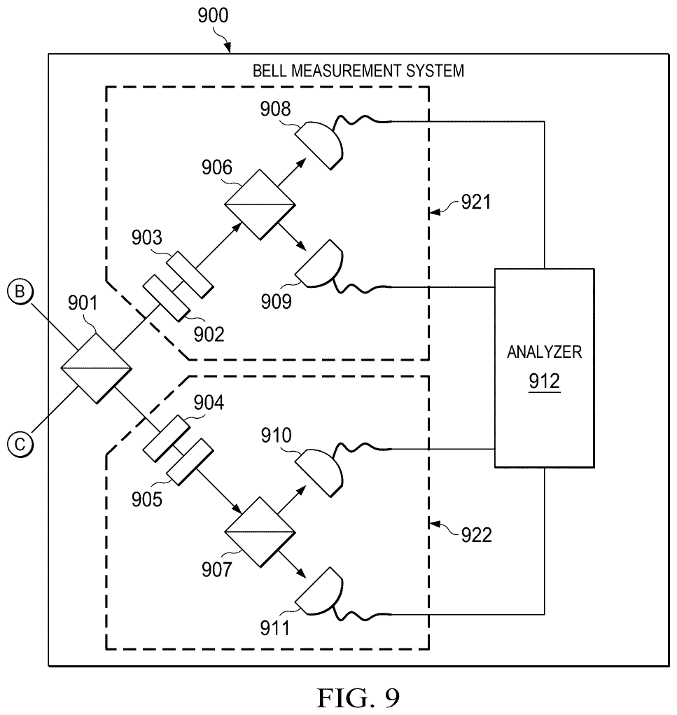

Next in FIG. 9, an illustration of a block diagram of a Bell measurement system is depicted in accordance with an illustrative embodiment. In this illustrative example, the Bell measurement system 900 is an example of one implementation for Bell measurement system 434 in FIG. 4. As depicted, Bell measurement system 900 comprises beam splitter 901, liquid crystal variable retarder 902, liquid crystal variable retarder 903, liquid crystal variable retarder 904, liquid crystal variable retarder 905, polarizing beam splitter (PBS) 906, polarizing beam splitter (PBS) 907, avalanche photodiode detector (APD) 908, avalanche photodiode detector (APD) 909, avalanche photodiode detector (APD) 910, avalanche photodiode detector (APD) 911, and analyzer 912.

In this example, first polarization analyzer 921 is formed by liquid crystal variable retarder 902, liquid crystal variable retarder 903, polarizing beam splitter (PBS) 906, avalanche photodiode detector (APD) 908, and avalanche photodiode detector (APD) 909. Second polarization analyzer 922 is formed from liquid crystal variable retarder 904, liquid crystal variable retarder 905, polarizing beam splitter (PBS) 907, avalanche photodiode detector (APD) 910, avalanche photodiode detector (APD) 911, and analyzer 912.

As depicted, photon B and photon C are combined by beam splitter 901. In this example, beam splitter 901 is a non-polarizing beam splitter with two input ports and two output ports.

In order to combine photons B and C, photon B is directed towards one input port of beam splitter 901 and photon C is directed towards second input port of beam splitter 901. Upon interfering at beam splitter 901, photon B and photon C are placed into an entangled state in the form of combined photon pair BC in a Bell state.

These two photons leave beam splitter 901 through either of the two available output ports. It is equally likely for both photon B and photon C to leave through the same output port or one photon to leave through each output port.

Photons leaving through the first output port are directed towards first polarization analyzer 921, avalanche photodiode detector 908, and avalanche photodiode detector 909. Photons leaving through the second output port are directed towards second polarization analyzer 922 to avalanche photodiode detector 910 and avalanche photodiode detector 911.

In this example the liquid crystal variable retarders and polarizing beam splitters operate to project photons C and D into a different polarization basis for detection. The liquid crystal variable retarders are not needed for entanglement swapping and are typically left at 0-wave retardance such that the photons are detected in the horizontal-vertical polarization basis. The liquid crystal variable retarders are used in this example to enable calibration and system health monitoring measurements.

In this example, entangled photon pairs are entangled photon pair AB and entangled photon pair CD (for example, as shown in first entangled photon pair 230 and second entangled photon pair 233 in FIG. 2). These entangled photon pairs are generated in the state described as follows:

$$\vert ψ 〉 = \frac{1}{\sqrt{2}} ( \vert HV 〉 + {e}^{i ϕ} \vert VH 〉 )$$

where ϕ is a phase factor that is dependent on the specific optics in the beam path and may be somewhat different between entangled photon pairs AB and CD. H is the horizontal polarization and V is the vertical polarization. The first symbol within the ket denotes the polarization of the first photon and the second symbol within the ket denotes the polarization of the second photon within an entangled photon pair.

For the entangled photon pair BC, after combination at beam splitter 901, photon B and photon C in this entangled photon pair is the combined entangled state of one of the four Bell states. Any of the four Bell states are generated with equal probability any time B and C are combined on the beam splitter.

The illustrative example is sensitive to two of those Bell states:

$$\vert {Ψ}^{+} 〉 = \frac{1}{\sqrt{2}} ( \vert HV 〉 + \vert VH 〉 ) or \vert {Ψ}^{-} 〉 = \frac{1}{\sqrt{2}} ( \vert HV 〉 - \vert VH 〉 ) .$$

Which of these two Bell states is formed is determined by which detectors in the Bell state measurement system register a photon.

Whenever the other two Bell states are generated, these states are not detected or registered as an entanglement swapping event. The illustrative example is not sensitive to the other two Bell states. These Bell states are

$$\vert {Φ}^{+} 〉 = \frac{1}{\sqrt{2}} ( \vert HH 〉 + \vert VV 〉 ) and \vert {Φ}^{-} 〉 = \frac{1}{\sqrt{2}} ( \vert HH 〉 - \vert VV 〉 ) .$$

In this illustrative example, analyzer 912 receives detections from the four avalanche photodiode detectors. These detections can be used by analyzer 912 to correlate single photon detection events to identify coincident detections. This correlation involves analyzing the timing of photon arrivals at different avalanche photodiode detectors to determine if arrival times at detectors occur simultaneously or within a selected time window. When two or more detectors register a photon within this window, the detections are considered coincident. This coincidence indicates that the photons may be entangled. In one illustrative example, analyzer 912 can be implemented using a time to digital converter (TDC) and a field programmable gate array (FPGA).

Measurements from detecting swapped entangled pairs AD and BC from the different polarization analyzers and the Bell state measurement system can be used in a tomography analysis. Tomographic analysis of photons with different polarizations is a technique used to reconstruct the quantum state of a system by measuring photons in various polarization bases. Photons can be polarized in different directions that are referred to as polarization states. Tomographic analysis involves collecting data from multiple polarization measurements and then using mathematical algorithms to reconstruct the full polarization state of the entangled photon pairs. In this example, this analysis can be performed using a controller such as controller 416, controller 438, and controller 426 in FIG. 4. In other illustrative examples, this analysis can also be performed by analyzer 806 in FIG. 8 or analyzer 912 in FIG. 9.

In this illustrative example, the examples of the polarization analyzer 800 in FIG. 8 and Bell measurement system 900 in FIG. 9 are used to implement polarization analyzer 413, polarization analyzer 423, and two polarization analyzers in Bell measurement system 434 in FIG. 4.

With this example, each polarization analyzer comprises two liquid crystal variable retarders (LCVR), one polarizing beam splitter (PBS), and two avalanche photodiode detectors (APDs). This combination of the eight liquid crystal variable retarders and eight avalanche photodiode detectors can increase the fraction of swapping events that can be detected. As a result, the overall entanglement swapping rate can be increased. Additionally, these components provide redundancy and robustness to failures of a subset of the avalanche photodiode detectors or liquid crystal variable retarders. For example, one of the avalanche photodiode detectors on each of the polarization analyzers can fail and the system can continue to execute entanglement swapping.

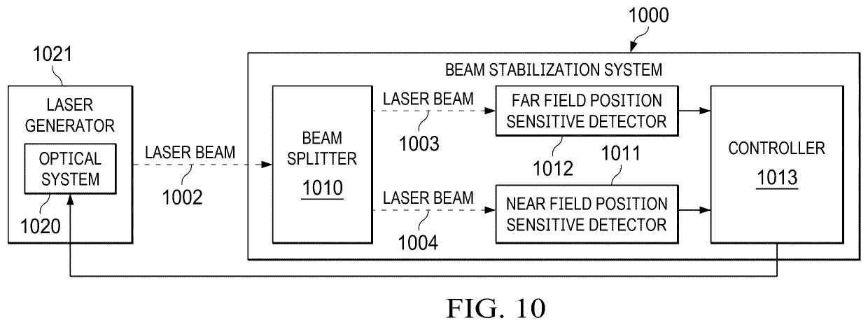

With reference now to FIG. 10, an illustration of a block diagram of a beam stabilization system is depicted in accordance with an illustrative embodiment. In this illustrative example, beam stabilization system 1000 operates to control the pointing of laser beam 1002 emitted by laser generator 1021. In this example, a spontaneous parametric down conversion crystal (not shown) can be located in the path of laser beam 1002 between laser generator 1021 and beam splitter 1010.

In this illustrative example, beam stabilization system 1000 comprises beam splitter 1010, near field position sensitive detector 1011, far field position sensitive detector 1012, and controller 1013.

In this illustrative example, beam splitter 1010 splits laser beam 1002 into laser beam 1003 and laser beam 1004. As depicted, laser beam 1003 is directed to far field position sensitive detector 1012, and laser beam 1002 is directed towards near field position sensitive detector 1011.

In this example, near field position sensitive detector 1011 and far field position sensitive detector 1012 are located roughly equidistant from beam splitter 1010. In this example, a lens (not shown) is located in laser beam 1003 with far field position sensitive detector 1012 located at the focus of the lens. These detectors generate information about the position of the respective laser beams. For example, these detectors can generate x and y coordinates of the laser beams on the surface of the detector. This can be used by controller 1013 to control the pointing of laser beam 1002. This control can be performed by sending control signals to optical system 1020 in laser generator 1021. This optical system can include mirrors, lenses, and controllers. In this manner, controller 1013 can make adjustments in the pointing laser beam 1002 to hit the desired locations in a spontaneous parametric down conversion crystal and also the desired locations to combine photons B and C at the combining beam splitter.

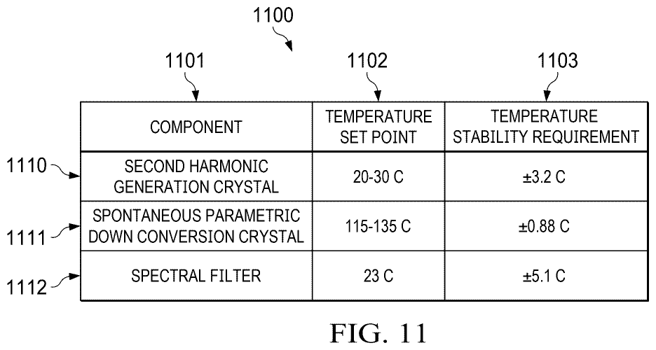

With reference next to FIG. 11, an illustration of a block diagram of temperature control loops is depicted in accordance with an illustrative embodiment. In this illustrative example, table 1100 identifies parameters for temperature control loops used to control the temperature of components in quantum entanglement systems. The control loops can be proportional integral derivative (PID) loops that can maintain a desired output by adjusting process control inputs based on an accumulation of past errors and the prediction of future errors.

In this illustrative example, the columns in table 1100 comprise the following columns: component 1101, temperature set point 1102, and temperature stability requirement 1103. Component 1101 identifies the optical components for which temperature is controlled. Temperature set point 1102 identifies temperatures that may be used to select a temperature to maintain for the optical components. Temperature stability requirement 1103 identifies a range from which the selected temperature can vary on a plus or minus basis.

In this example, three entries are present. Entry 1110 is for a second harmonic generation crystal in which the temperature maintained for this crystal can be a temperature selected from a range of 20 degrees C. to 30 degrees C. plus or minus 3.2 degrees C. Entry 1111 is for a spontaneous parametric down conversion crystal in which the temperature maintained for this crystal can be selected from a range of 115 degrees C. to 135 degrees C. plus or minus 0.88 degrees C., and entry 1112 is for a spectral filter in which the temperature range maintained for this filter can be a temperature selected such as 23 degrees C. plus or minus 5.1 degrees C.

The examples of different components and systems in FIGS. 5-11 are provided as an example of one implementation and not intended to limit the manner in which the systems can be implemented in other examples. For example, spontaneous parametric down conversion crystal system 600 is shown as having a single spontaneous parametric down conversion crystal. In other illustrative examples, one or more spontaneous parametric down conversion crystals can be present in addition to this crystal. Further, when more than one spontaneous parametric down conversion crystal is present, different types of crystals can be used.

In yet another illustrative example, some of these components can be optional. For example, beam stabilization system 1000 may be omitted in some illustrative examples. In yet another illustrative example, two liquid crystal variable retarders can be used in a polarization analyzer instead of four liquid crystal variable retarders in Bell measurement system 900 in FIG. 9.

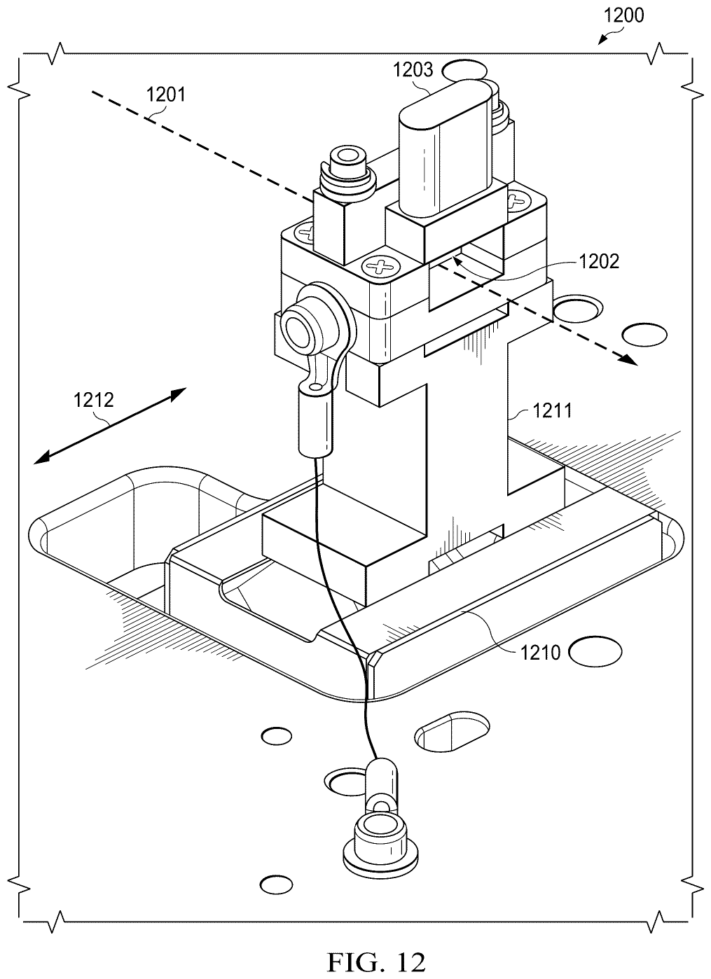

With reference to FIG. 12, a pictorial illustration of a crystal management system for a spontaneous parametric down conversion crystal is depicted in accordance with an illustrative embodiment. In this illustrative example, crystal management system 1200 is an example of an implementation for crystal management system 220 in FIG. 2.

As depicted, laser beam path 1201 is a path for laser beam pulses that extends through spontaneous parametric down conversion crystal 1202. In this illustrative example, resistive heater 1203 is an example of heater 701 in temperature controller 700 in FIG. 7. This heater heats spontaneous parametric down conversion crystal 1202 to an elevated temperature that is an annealing temperature for this crystal. The heating is performed continuously during the generation of entangled photon pairs.

Additionally, crystal management system 1200 also includes translation stage 1210. This translation stage is an example of an implementation for translation system 241 in FIG. 2. In this example, translation stage 1210 moves crystal holder 1211 along axis 1212 such that the laser beam pulses transmitted along laser beam path 1201 hit spontaneous parametric down conversion crystal 1202 at different locations during the generation of entangled photon pairs. In other words, the position of spontaneous parametric down conversion crystal 1202 is moved along axis 1212 such that the laser beam pulses hit spontaneous parametric down conversion crystal 1202 at different locations based on the position of spontaneous parametric down conversion crystal 1202 moving along axis 1212. Thus, translation stage 1210 can move spontaneous parametric down conversion crystal 1202 during the generation of entangled photon pairs can reduce degradation of spontaneous parametric down conversion crystal 1202.

In this example, the use of a thermal management system such as resistive heater 1203 and a translation system such as translation stage 1210 in crystal management system 1200 can increase the lifespan of spontaneous parametric down conversion crystal 1202. This increase in lifespan can occur through maintaining spontaneous parametric down conversion crystal 1202 and annealing temperature during the generation of integral photon pairs such that the degradation to spontaneous parametric down conversion crystal 1202 can be reduced or reversed. Using translation stage 1210 to move the position of spontaneous parametric down conversion crystal 1202 during the generation of entangled photon pairs also reduces the degradation occurring at any particular location on spontaneous parametric down conversion crystal 1202 because of the continuous movement in the position of spontaneous parametric down conversion crystal 1202.

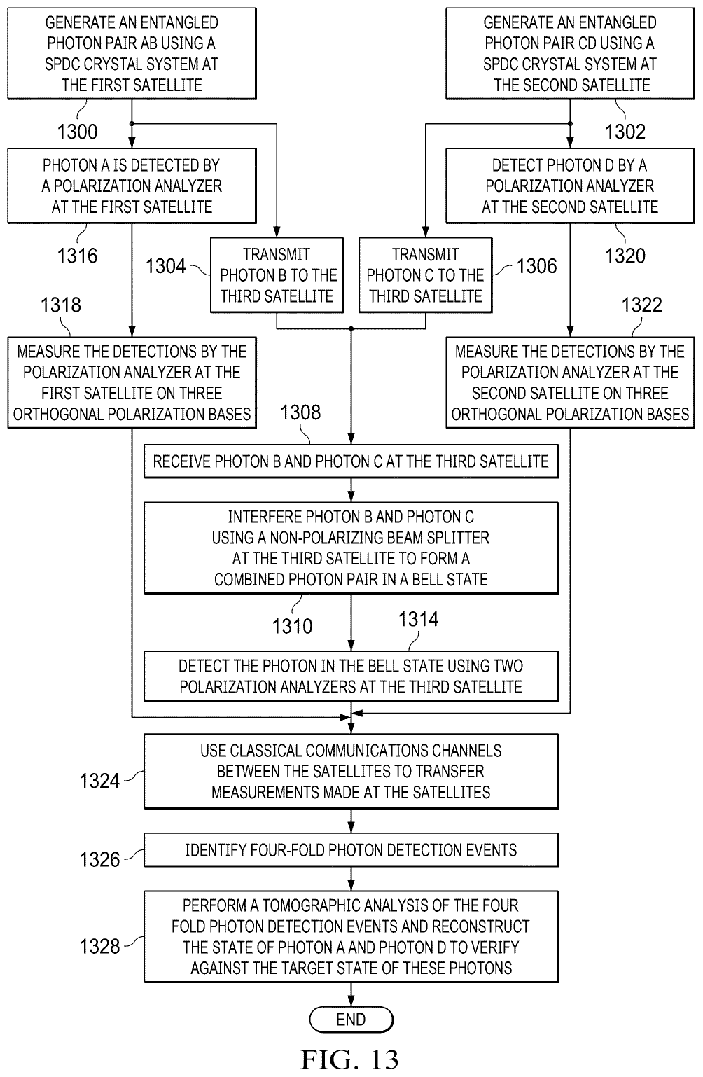

Turning next to FIG. 13, an illustration of a flowchart of a process for performing entanglement swapping is depicted in accordance with an illustrative embodiment. The process in FIG. 13 can be implemented in hardware, software, or both. When implemented in software, the process can take the form of program instructions that are run by one of more processor units located in one or more hardware devices in one or more computer systems. For example, the process can be implemented in components quantum entitlement system such as quantum entanglement system 400 in FIG. 4.

The process generates an entangled photon pair AB using a SPDC crystal system at the first satellite (operation 1300). The process also generates an entangled photon pair CD using a SPDC crystal system at the second satellite (operation 1302). The process transmits photon B to third satellite (operation 1304) and transmits photon C to third satellite (operation 1306). The process receives photon B and photon C at the third satellite (operation 1308). The process interferes photon B and photon C using a non-polarizing beam splitter at the third satellite to form a combined photon pair in a Bell state (operation 1310).

The process detects the photon in the Bell state using two polarization analyzers at the third satellite (operation 1314).

While the combination of detections occur at the third satellite, parallel processes can occur at the first satellite and the second satellite. As depicted, photon A is detected by a polarization analyzer at satellite 1 (operation 1316). These detections are measured by the polarization analyzer at the first satellite on three orthogonal polarization bases (operation 1318). Further, photon D is detected by a polarization analyzer at the second satellite (operation 1320). These detections are measured by the polarization analyzer at the second satellite on three orthogonal polarization bases (operation 1322).

Once the measurements are made at all three satellites, then these measurements can be used to determine whether swapping has occurred and whether eavesdropping has occurred. The process uses classical communications channels between the satellites to transfer measurements made at the satellites (step 1324). These measurements provide information about photo detection times, polarization bases for the detected photons, and other information.

The process identifies four-fold photon detection events (step 1326). In operation 1326, four-fold photon detection events are events for the simultaneous detection of four photons, such as A, B, C, and D across multiple detectors within a specific time window. The detection of these four photons enables confirming the entanglement and other quantum correlations between the photons.

The process then performs a tomographic analysis of the four fold photon detection events and reconstructs the state of photon A and photon D to verify against the target state of these photons (operation 1328). The process terminates thereafter.

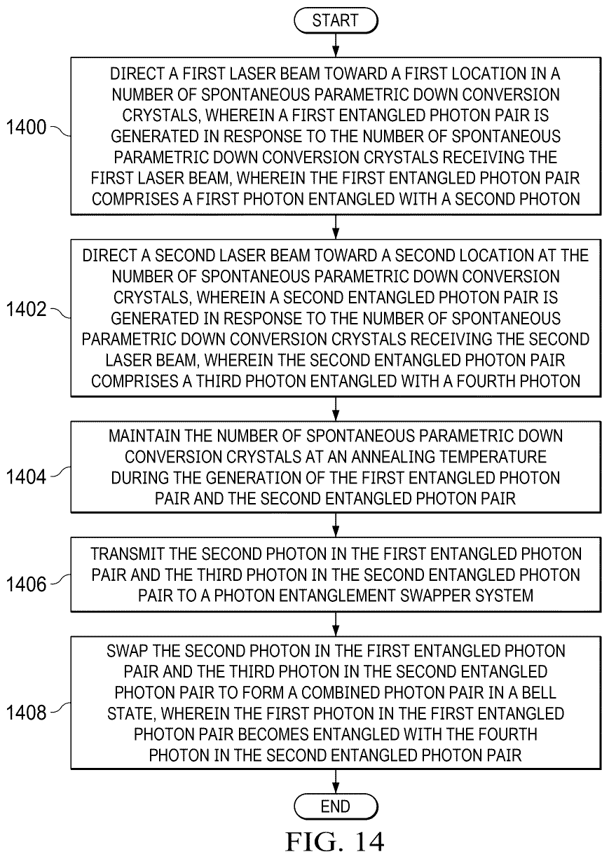

Turning now to FIG. 14, an illustration of a flowchart of a process for generating entangled photon pairs is depicted in accordance with an illustrative embodiment. The process in this flowchart can be implemented in a quantum entanglement system such as quantum entanglement system 202 in FIG. 2 and quantum entanglement system 400 in FIG. 4. Further, these processes can be performed using one or more components in these entanglement systems.

The process directs a first laser beam toward a first location in a number of spontaneous parametric down conversion crystals, wherein a first entangled photon pair is generated in response to the number of spontaneous parametric down conversion crystals receiving the first laser beam, wherein the first entangled photon pair comprises a first photon entangled with a second photon (operation 1400). The process directs a second laser beam toward a second location at the number of spontaneous parametric down conversion crystals, wherein a second entangled photon pair is generated in response to the number of spontaneous parametric down conversion crystals receiving the second laser beam, wherein the second entangled photon pair comprises a third photon entangled with a fourth photon (operation 1402). In this example, the first location and the second location can be in same crystal or different crystal when the number of spontaneous parametric down conversion crystals are two or more crystals and not a single crystal.

The process maintains the number of spontaneous parametric down conversion crystals at an annealing temperature during the generation of the first entangled photon pair and the second entangled photon pair (operation 1404). The process transmits the second photon in the first entangled photon pair and the third photon in the second entangled photon pair to a photon entanglement swapper system (operation 1406). The process swaps the second photon in the first entangled photon pair and the third photon in the second entangled photon pair to form a combined photon pair in a Bell state, wherein the first photon in the first entangled photon pair becomes entangled with the fourth photon in the second entangled photon pair (operation 1408). The process terminates thereafter. In this example, the swapping can occur by interfering the second photon and the third photon at a beam splitter.

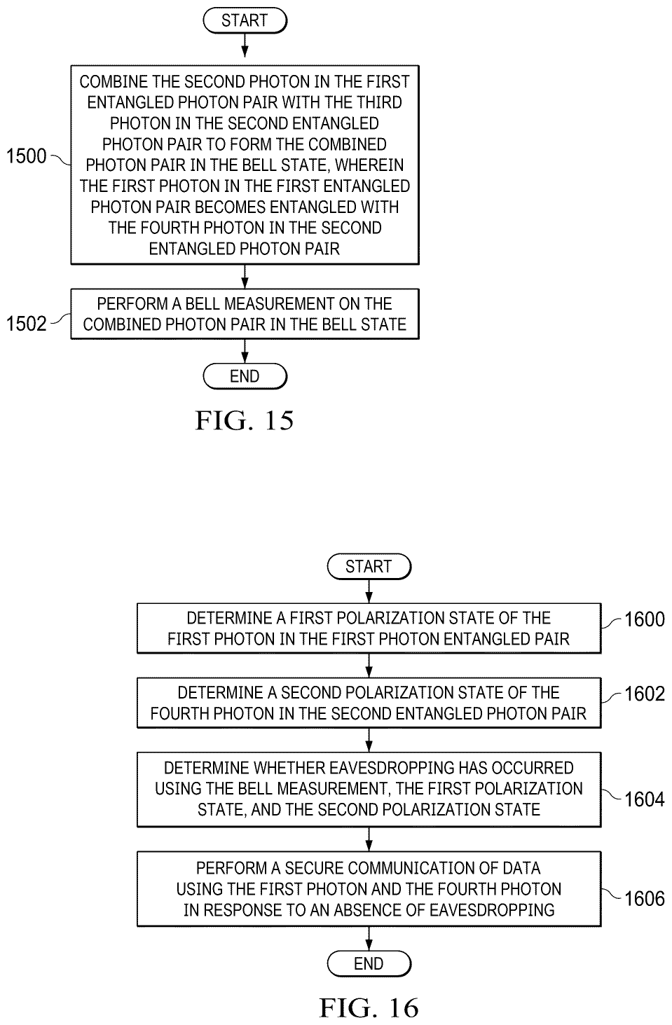

With reference next to FIG. 15, an illustration of a flowchart for swapping photon entanglement is depicted in accordance with an illustrative embodiment. The process in this figure is an example of an implementation for operation 1408 in FIG. 14.

The process begins by combining the second photon in the first entangled photon pair with the third photon in the second entangled photon pair to form the combined photon pair in the Bell state, wherein the first photon in the first entangled photon pair becomes entangled with the fourth photon in the second entangled photon pair (operation 1500). The process performs a Bell measurement on the combined photon pair in the Bell state (operation 1502). The process terminates thereafter. In this example, the Bell measurement can be performed to confirm that the swapping of entanglement between the first entangled photon pair and the second entangled photon pair has occurred such that the first photon in the first entangled photon pair becomes entangled with the fourth photon in the second entangled photon pair.

Turning to FIG. 16, an illustration of a flowchart of a process for performing secure communications using the entangled photons is depicted in accordance with an illustrative embodiment. The process in this figure is an example of additional operations that can be performed with the operations in FIG. 14 and FIG. 15.

The process begins by determining a first polarization state of the first photon in the first photon entangled pair (operation 1600). The process determines a second polarization state of the fourth photon in the second entangled photon pair (operation 1602).

The process determines whether eavesdropping has occurred using the Bell measurement, the first polarization state, and the second polarization state (operation 1604). The process performs a secure communication of data using the first photon and the fourth photon in response to an absence of eavesdropping (operation 1606). The process terminates thereafter. In operation 1606, secure communication of data is selected from a group of techniques comprising quantum key distribution, quantum teleportation, quantum secret sharing, entanglement-based quantum authentication, and other suitable quantum communication techniques using entangled photons.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, the illustrative examples provide a method, apparatus, and system quantum entanglement of photons. In one illustrative example, a quantum entanglement system comprises a laser system, a spontaneous parametric down conversion crystal system, and a thermal management system. The laser system is configured to generate a laser beam. The spontaneous parametric down conversion crystal system comprises a spontaneous parametric down conversion crystal configured to receive the laser beam at a spontaneous parametric down conversion crystal and generates an entangled photon pair in response to the spontaneous parametric down conversion crystal receiving the laser beam. The thermal management system is configured to maintain the spontaneous parametric down conversion crystal at an annealing temperature during a generation of the entangled photon pair.

The thermal management system enables increasing the lifespan of crystals used to generate entangled photons. Further, this thermal management system also enables selecting laser generators having shorter wavelengths and higher peak powers. These types of lasers may increase degradation to a spontaneous parametric down conversion crystal as compared to larger lasers without the use of the thermal management system. Further, with the use of temperature control loops for other components such as a second harmonic generation crystal and a spectral filter, increased performance in generating entangled photon pairs can occur.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A quantum entanglement system comprising:
a laser system configured to generate a first laser beam and a second laser beam;
a spontaneous parametric down conversion crystal system comprising:
a number of spontaneous parametric down conversion crystals configured to:
receive the first laser beam at a first location in the number of spontaneous parametric down conversion crystals;
generate a first entangled photon pair in response to the number of spontaneous parametric down conversion crystals receiving the first laser beam, wherein the first entangled photon pair comprises a first photon entangled with a second photon;
receive the second laser beam at a second location in the number of spontaneous parametric down conversion crystals; and
generate a second entangled photon pair in response to the number of spontaneous parametric down conversion crystals receiving the second laser beam, wherein the second entangled photon pair comprises a third photon entangled with a fourth photon;
a thermal management system configured to:
maintain the number of spontaneous parametric down conversion crystals at an annealing temperature during a generation of the first entangled photon pair and the second entangled photon pair;
a translation system configured to:
move a position of the number of spontaneous parametric down conversion crystals relative to the first laser beam and the second laser beam; and
a photon entanglement swapper system configured to:
swap entanglement between the first entangled photon pair and the second entangled photon pair, wherein the second photon in the first entangled photon pair is combined with the third photon in the second entangled photon pair to form a combined photon pair in a Bell state and wherein the first photon in the first entangled photon pair becomes entangled with the fourth photon in the second entangled photon pair.

2. The quantum entanglement system of claim 1, wherein the quantum entanglement system is connected to a satellite.

3. The quantum entanglement system of claim 1, wherein:
the laser system comprises a first laser generator connected to a first platform and that generates the first laser beam and a second laser generator connected to a second platform and that generates the second laser beam;
the number of spontaneous parametric down conversion crystals comprises a first spontaneous parametric down conversion crystal connected to the first platform and a second spontaneous parametric down conversion crystal connected to the second platform;
the thermal management system comprises a first temperature controller connected to the first platform and is configured to maintain the first spontaneous parametric down conversion crystal at the annealing temperature during the generation of the first entangled photon pair and a second temperature controller connected to the second platform and is configured to maintain the second spontaneous parametric down conversion crystal at the annealing temperature during the generation of the second entangled photon pair;
the translation system comprises a first translator connected to the first platform and is configured to move the first spontaneous parametric down conversion crystal and a second translator connected to the second platform and is configured to move the second spontaneous parametric down conversion crystal; and
the photon entanglement swapper system is connected to a platform selected from a group comprising the first platform, the second platform and a third platform.

4. The quantum entanglement system of claim 3, wherein the quantum entanglement system is deployable by being connected to the first platform, the second platform, and the third platform, which are each selected from a group comprising a mobile platform, a stationary platform, a land-based structure, an aquatic-based structure, a space-based structure, a ground station, a satellite, a space station, a spacecraft, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a submarine, an automobile, a power plant, a bridge, a dam, a house, a manufacturing facility, and a building.

5. The quantum entanglement system of claim 1, wherein:
the laser system comprises a first laser generator that generates the first laser beam in a first satellite and a second laser generator that generates the second laser beam in a second satellite;
the number of spontaneous parametric down conversion crystals comprises a first spontaneous parametric down conversion crystal connected to the first satellite and a second spontaneous parametric down conversion crystal connected to the second satellite;
the translation system comprises a first translator connected to the first satellite and is configured to move the first spontaneous parametric down conversion crystal and a second translator connected to the second satellite and is configured to move the second spontaneous parametric down conversion crystal;
the thermal management system comprises a first temperature controller connected to the first satellite and is configured to maintain the first spontaneous parametric down conversion crystal at the annealing temperature during the generation of the first entangled photon pair and a second temperature controller connected to the second satellite and is configured to maintain the second spontaneous parametric down conversion crystal at the annealing temperature during the generation of the second entangled photon pair; and
the photon entanglement swapper system connected to a platform selected from a group comprising a third satellite and a ground station.

6. The quantum entanglement system of claim 1, wherein the translation system moves the position of the number of spontaneous parametric down conversion crystals on a number of axes.

7. The quantum entanglement system of claim 1, wherein the thermal management system maintains the number of spontaneous parametric down conversion crystals at the annealing temperature that is selected to minimize degradation in the number of spontaneous parametric down conversion crystals while maximizing photon pair generation by the number of spontaneous parametric down conversion crystals.

8. The quantum entanglement system of claim 1, wherein the thermal management system performs at least one of heating or cooling of the number of spontaneous parametric down conversion crystals to maintain the number of spontaneous parametric down conversion crystals at the annealing temperature during the generation of the first entangled photon pair and the second entangled photon pair.

9. The quantum entanglement system of claim 1, wherein the thermal management system maintains the number of spontaneous parametric down conversion crystals at the annealing temperature during the generation of the first entangled photon pair and the second entangled photon pair using a proportional-integral-derivative control loop.

10. The quantum entanglement system of claim 1, wherein the thermal management system maintains the number of spontaneous parametric down conversion crystals at the annealing temperature that is from about 50 degrees C. to about 150 degrees C.

11. The quantum entanglement system of claim 1, wherein the number of spontaneous parametric down conversion crystals is comprised of a number of materials selected from at least one of periodically poled potassium titanyl phosphate (ppKTP), potassium titanyl phosphate (KTP), potassium titanyl arsenate (KTA), rubidium titanyl phosphate (RTP), rubidium doped potassium titanyl phosphate (RB:KTP), potassium dihydrogen phosphate (KDP), bismuth triborate (BiBO), beta barium borate (BBO), and periodically poled lithium niobate (PPLN).

12. The quantum entanglement system of claim 1, wherein the photon entanglement swapper system comprises:
a beam splitter configured to:
receive the second photon from the first entangled photon pair and the third photon from the second entangled photon pair; and
output the second photon and the third photon as the combined photon pair in the Bell state, wherein the first photon in the first entangled photon pair becomes entangled with the fourth photon in the second entangled photon pair;
a first polarization analyzer configured to:
receive the combined photon pair in the Bell state and generate a first measurement of the combined photon pair in the Bell state; and
a second polarization analyzer configured to:
receive the combined photon pair in the Bell state and generate a second measurement of the combined photon pair in the Bell state.

13. The quantum entanglement system of claim 12 further comprising:
a communications system configured to:
determine whether eavesdropping has occurred using the first measurement and the second measurement; and
perform a secure communication of data using the first photon and the fourth photon in response to an absence of eavesdropping.

14. The quantum entanglement system of claim 13, wherein the secure communication of data is selected from a group of techniques comprising quantum key distribution, quantum teleportation, quantum secret sharing, and entanglement-based quantum authentication.

15. A quantum entanglement system comprising:
a laser system configured to generate a laser beam;
a spontaneous parametric down conversion crystal system comprising:
a spontaneous parametric down conversion crystal configured to:
receive the laser beam at the spontaneous parametric down conversion crystal configured to:
generate an entangled photon pair in response to the spontaneous parametric down conversion crystal receiving the laser beam; and
a thermal management system configured to:
maintain the spontaneous parametric down conversion crystal at an annealing temperature during a generation of the entangled photon pair.

16. The quantum entanglement system of claim 15, wherein the entangled photon pair is a first photon entangled with a second photon and further comprising:
a photon entanglement swapper system configured to:
swap entanglement between the first entangled photon pair and a second entangled photon pair with a third photon entangled with a fourth photon, wherein the second photon in the first entangled photon pair is combined with the third photon in the second entangled photon pair to form a combined photon pair in a Bell state and wherein the first photon in the first entangled photon pair becomes entangled with the fourth photon in the second entangled photon pair.

17. The quantum entanglement system of claim 16, wherein the photon entanglement swapper system comprises:
a beam splitter configured to:
receive the second photon and the third photon; and
output the second photon and the third photon as the combined photon pair in the Bell state, wherein the first photon in the first entangled photon pair becomes entangled with the fourth photon in the second entangled photon pair;
a first polarization analyzer having an input configured to:
receive the combined photon pair in the Bell state and generate a first measurement of the combined photon pair in the Bell state; and
a second polarization analyzer configured to:
receive the combined photon pair in the Bell state and generate a second measurement of the combined photon pair in the Bell state.

18. The quantum entanglement system of claim 15 further comprising:
a translation system configured to:
move a position of the spontaneous parametric down conversion crystal relative to the laser beam.

19. The quantum entanglement system of claim 15 further comprising:
a translation system configured to:
continuously move a position of the spontaneous parametric down conversion crystal relative to the laser beam.

20. The quantum entanglement system of claim 19, wherein the translation system moves the position of the spontaneous parametric down conversion crystal on a number of axes.

21. The quantum entanglement system of claim 15, wherein the thermal management system maintains the spontaneous parametric down conversion crystal at the annealing temperature that is selected to minimize degradation in spontaneous parametric down conversion crystal while maximizing photon pair generation by the spontaneous parametric down conversion crystal.

22. The quantum entanglement system of claim 15, wherein the thermal management system performs at least one of heating or cooling of the spontaneous parametric down conversion crystal to maintain the spontaneous parametric down conversion crystal at the annealing temperature during the generation of the entangled photon pair.

23. The quantum entanglement system of claim 15, wherein the thermal management system maintains the spontaneous parametric down conversion crystal at the annealing temperature during the generation of the entangled photon pair using a proportional-integral-derivative control loop.

24. The quantum entanglement system of claim 15, wherein the thermal management system maintains the spontaneous parametric down conversion crystal at the annealing temperature that is from about 115 degrees C. to about 135 degrees C.

25. The quantum entanglement system of claim 15, wherein the spontaneous parametric down conversion crystal is comprised of a material selected from a group comprising periodically poled potassium titanyl phosphate (ppKTP), potassium titanyl phosphate (KTP), potassium titanyl arsenate (KTA), rubidium titanyl phosphate (RTP), rubidium doped potassium titanyl phosphate (RB:KTP), potassium dihydrogen phosphate (KDP), bismuth triborate (BiBO), beta barium borate (BBO), and periodically poled lithium niobate (PPLN).

26. The quantum entanglement system of claim 15 further comprising:
a platform, wherein the laser system, the spontaneous parametric down conversion crystal system, and the thermal management system are connected to the platform.

27. The quantum entanglement system of claim 26, wherein the platform is selected from a group comprising a mobile platform, a stationary platform, a land-based structure, an aquatic-based structure, a space-based structure, a ground station, a satellite, a space station, a spacecraft, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a submarine, an automobile, a power plant, a bridge, a dam, a house, a manufacturing facility, and a building.

28. A method for generating entangled photon pairs, the method comprising:
directing a first laser beam toward a first location in a number of spontaneous parametric down conversion crystals, wherein a first entangled photon pair is generated in response to the number of spontaneous parametric down conversion crystals receiving the first laser beam, wherein the first entangled photon pair comprises a first photon entangled with a second photon;
directing a second laser beam toward a second location in the number of spontaneous parametric down conversion crystals, wherein a second entangled photon pair is generated in response to the number of spontaneous parametric down conversion crystals receiving the second laser beam, wherein the second entangled photon pair comprises a third photon entangled with a fourth photon;
maintaining the number of spontaneous parametric down conversion crystals at an annealing temperature during the generation of the first entangled photon pair and the second entangled photon pair;
transmitting the second photon in the first entangled photon pair and the third photon in the second entangled photon pair to a photon entanglement swapper system; and
swapping the second photon in the first entangled photon pair and the third photon in the second entangled photon pair to form a combined photon pair in a Bell state, wherein the first photon in the first entangled photon pair becomes entangled with the fourth photon in the second entangled photon pair.

29. The method of claim 28, wherein swapping comprises:
combining the second photon in the first entangled photon pair with the third photon in the second entangled photon pair to form the combined photon pair in the Bell state, wherein the first photon in the first entangled photon pair becomes entangled with the fourth photon in the second entangled photon pair; and
performing a Bell measurement on the combined photon pair in the Bell state.

30. The method of claim 29 further comprising:
determining a first polarization state of the first photon in the first photon entangled pair;
determining a second polarization state of the fourth photon in the second entangled photon pair;
determining whether eavesdropping has occurred using the Bell measurement, the first polarization state, and the second polarization state; and
performing a secure communication of data using the first photon and the fourth photon in response to an absence of eavesdropping.

31. The method of claim 30, wherein the secure communication of data is selected from a group of techniques comprising quantum key distribution, quantum teleportation, quantum secret sharing, and entanglement-based quantum authentication.
